(19) United States
(12) Patent Application Publication
(10) Pub. No.: US 2019/0276230 A1
(43) Pub. Date: Sep. 12, 2019

(54) WASTE RECEPTACLE DEVICE

(71) Applicant: Russell Patrick Bilton, Rotherham (GB)

(72) Inventor: Russell Patrick Bilton, Rotherham (GB)

(21) Appl. No.: 16/293,875

(22) Filed: Mar. 6, 2019

(30) Foreign Application Priority Data
Mar. 6, 2018 (GB) 1803556.8

(51) Int. Cl. B65F 1/06; B65F 1/00; B65F 1/16

(52) U.S. Cl. CPC B65F 1/065; B65F 2001/1489; B65F 1/1646; B65F 1/0013

(57) ABSTRACT

A waste receptacle device 101 for compacting waste 1101 comprises a container 102 for receiving a waste bag 103, a suction mechanism 201 and a heating mechanism 202. The suction mechanism extracts a fluid such as air 1103 from the interior of the waste bag so as to compact the waste bag to a compacted state. The heating mechanism applies heat 1106 to an internal cavity 105 of the container to maintain the waste bag in the compacted state. A method of compacting waste is also disclosed.

### CROSS REFERENCE TO RELATED APPLICATIONS

This application claims priority from United Kingdom Patent Application number 18 03 556.8, filed on 6 Mar. 2018, the whole contents of which are incorporated herein by reference.

### BACKGROUND OF THE INVENTION

The present invention relates to a waste receptacle device and a method of compacting waste.

Waste receptacle devices are known which provide a container in which to store waste or rubbish. Typically, flexible waste bags are placed inside such containers, filled with waste or rubbish and, once substantially full, the flexible waste bag is removed from the container for transport to waste disposal plants or landfill.

In domestic environments, waste collection services are becoming less frequent. This presents a problem in that a typical waste receptacle, such as a wheelie bin or trash can provided by a local authority, and which holds a finite number of filled waste bags, can become overfilled or unable to accommodate the amount of waste or number of bags produced by a typical household. In these situations, a user is required to pay additional fees to have excess waste removed, or take their own rubbish to waste disposal sites which may be inconvenient.

Waste receptacles have been proposed which provide systems which compact waste into smaller packages. However, compaction of waste filled bags simply removes the air, and without being airtight, the bags quickly fill with air again and, as a result, do not remain compacted.

### BRIEF SUMMARY OF THE INVENTION

According to an aspect of the present invention, there is provided a waste receptacle device for compacting waste, comprising: a container including a waste bag comprising a material which hardens in response to an application of heat; a suction mechanism configured to extract a fluid such as air from an interior of said waste bag so as to compact the waste bag to a compacted state; a heating mechanism configured to apply heat to an internal cavity of said container following activation of said suction mechanism to maintain said waste bag in said compacted state; and a closure mechanism configured to secure said waste bag in a closed configuration; wherein said closure mechanism comprises a heat-sealing device configured to apply heat around the neck of said waste bag.

According to a further aspect of the present invention, there is provided a method of compacting waste, comprising the steps of: providing a waste bag in a container for receiving waste, said waste bag comprising a material which hardens in response to an application of heat; applying suction by means of a suction mechanism to the interior of said waste bag to compact said waste bag to a compacted state; and providing heat to an internal cavity of said container by means of a heating mechanism to maintain said waste bag in said compacted state; and securing said waste bag in a closed configuration by activating a closure mechanism comprising a heat-sealing device which applies heat around the neck of said waste bag.

### BRIEF DESCRIPTION OF THE SEVERAL VIEWS OF THE DRAWINGS

The invention will now be described by way of example only, with reference to the accompanying drawings, of which:

FIG. 1 shows a waste receptacle device;

FIG. 2 shows a block diagram illustrating a waste receptacle device;

FIG. 3 shows a first embodiment of a suction mechanism for a waste receptacle device;

FIG. 4 shows a second embodiment of a suction mechanism for a waste receptacle device;

FIG. 5 shows a heating mechanism for a waste receptacle device;

FIG. 6 shows a first embodiment of a closure mechanism for a waste receptacle device;

FIG. 7 shows a second embodiment of a closure mechanism for a waste receptacle device;

FIG. 8 shows a third embodiment of a closure mechanism for a waste receptacle device;

FIG. 9 shows a further embodiment of a closure mechanism for a waste receptacle device;

FIG. 10 shows a diagram of a method of compacting waste;

FIG. 11 shows a container including a waste bag in an uncompacted state prior to the application of the method of FIG. 10;

FIG. 12 shows a container including a waste bag in a compacted state following application of the method of FIG. 10.

### DETAILED DESCRIPTION OF THE INVENTION

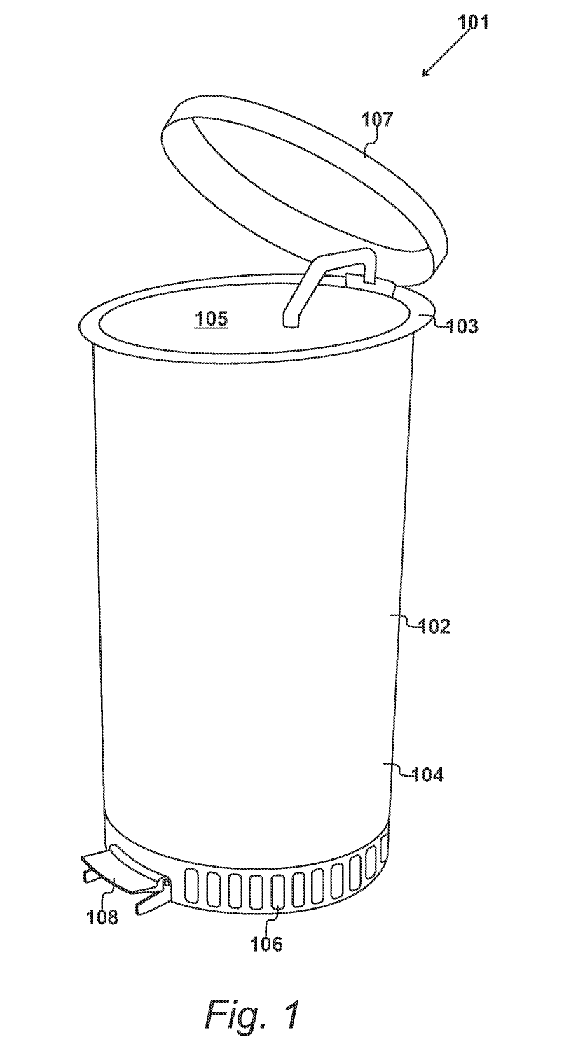

### FIG. 1

A waste receptacle device 101 in accordance with the present invention is shown in FIG. 1. Waste receptacle device 101 comprises a container 102 which is suitable for receiving a waste bag, such as waste bag 103. Container 102 comprises a body 104 having an internal cavity 105 into which waste bag 103 is received. In use, therefore, internal cavity 105 can receive waste into waste bag 103, and the waste bag can then be removed from container 102 for disposal.

Container 102, in this illustrated embodiment, is substantially cylindrical, however it is appreciated that alternative shapes such as a cuboid may be utilized. In an embodiment, the exterior of container 102 comprises an anodized rolled steel exterior. It is further appreciated that container 102 can comprise any suitable material, but is typically provided in metallic materials, sturdy plastic materials or similar.

Container 102 includes a plurality of venting holes 106 which are distributed around a lower portion of the container. Venting holes 106 are configured to provide inlet and outlet means as necessary for air.

Container 102 further comprises a lid 107. In the illustrated embodiment, lid 107 is opened and closed by an input device 108, which is a pedal. In further embodiments, input device 108 comprises a push button located on an exterior surface of container 102. Input device 108 is not only configured to open lid 107 to allow access into internal cavity 105, but is also configured to provide an activation means so as to enable activation of a suction mechanism and a heating mechanism as will be now be described in further detail.

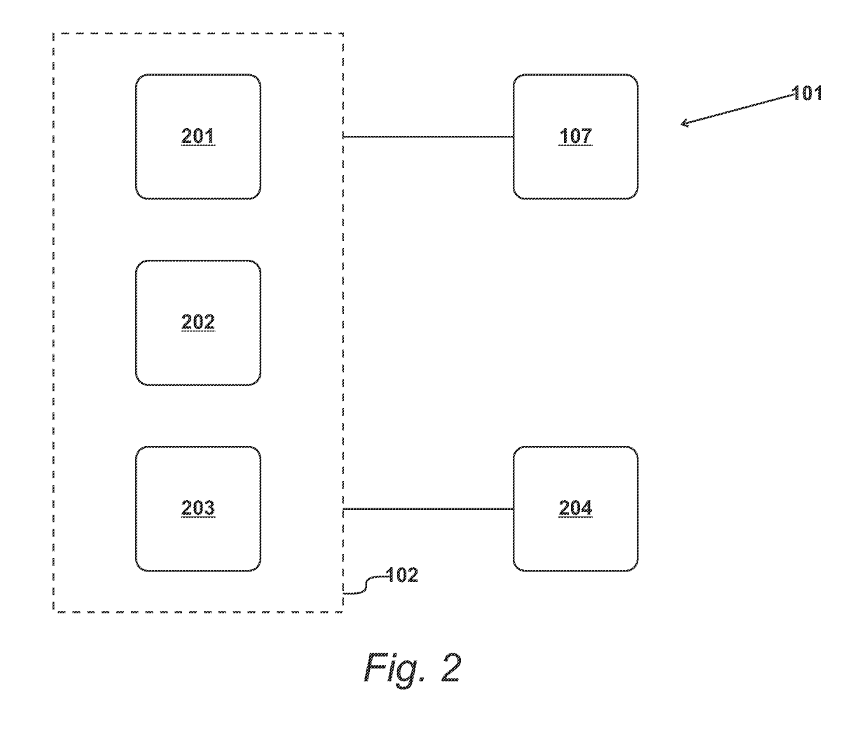

### FIG. 2

A block diagram illustrating a waste receptacle device, such as waste receptacle device 101 is shown in a diagrammatic form in FIG. 2. Waste receptacle device 101 comprises container 102 which further comprises a suction mechanism 201 and a heating mechanism 202. Container 102 further includes a closure mechanism 203. In the embodiment, suction mechanism 201, heating mechanism 202 and closure mechanism 203 are contained internally within container 102. Thus, in an embodiment, the mechanisms are not visible to a user in normal use, and a user only sees internal cavity 105 into which waste is received. On an external surface of container 102 an activation means 107 is provided. As described in FIG. 1, this may comprise a pedal or a push button or any other suitable means by which suction mechanism 201, heating mechanism 202 and additionally, closure mechanism 203 may be activated.

Waste receptacle device 101 further comprises a power source 204 configured to provide power to suction mechanism 201 and heating mechanism 202. In the embodiment, power source 204 is shown external to container 102. In this embodiment, therefore, power source 204 is provided from the mains. However, in a further embodiment, power source 204 comprises a battery, and preferably, a rechargeable battery. In a further embodiment, the rechargeable battery is arranged as an integral part of the lid 107 of container 102.

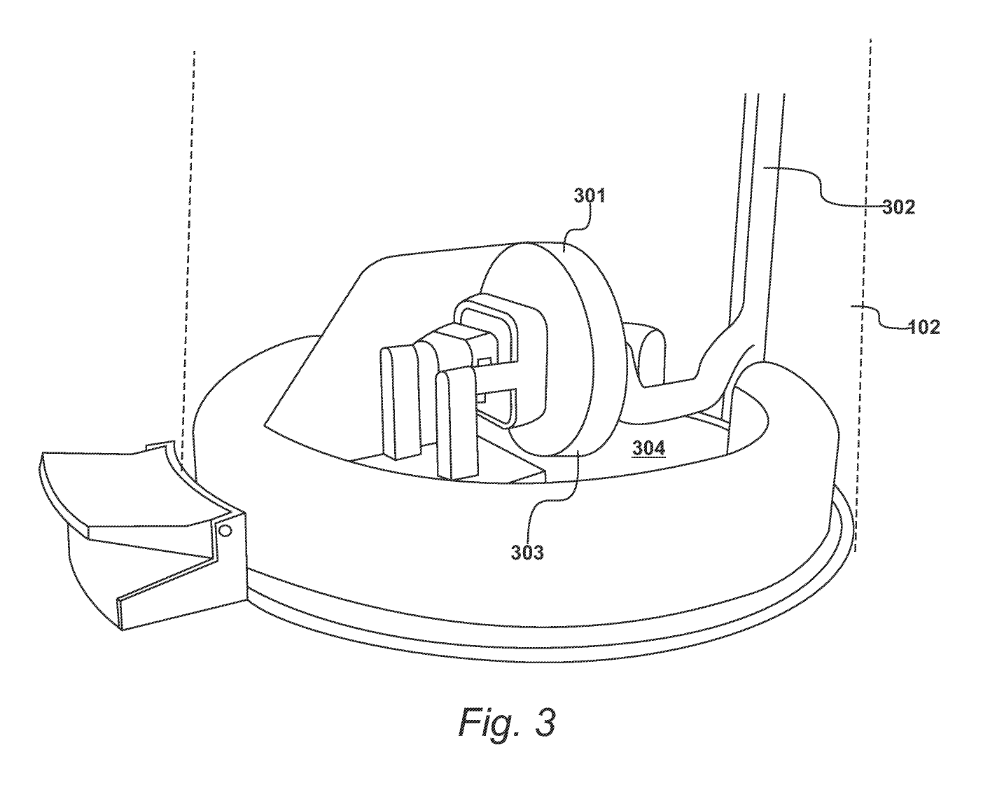

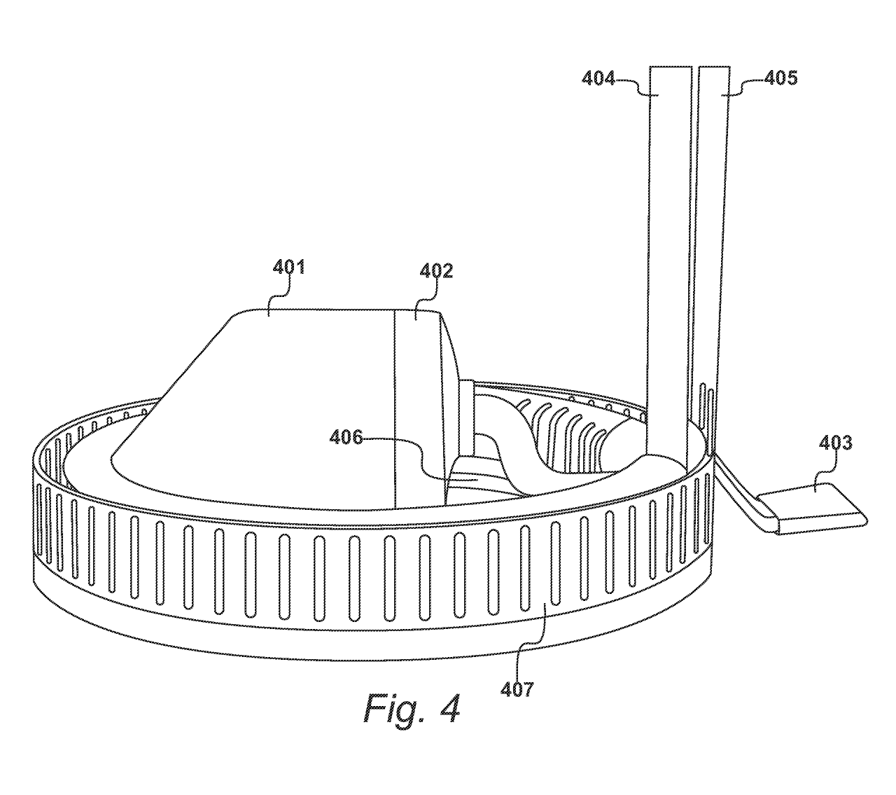

Suction mechanism 201 is configured to extract a fluid such as air from an interior of a waste bag, such as waste bag 103 so as to compact the waste bag into a compacted state. Examples of suction mechanisms in accordance with the invention will be described with respect to FIGS. 3 and 4.

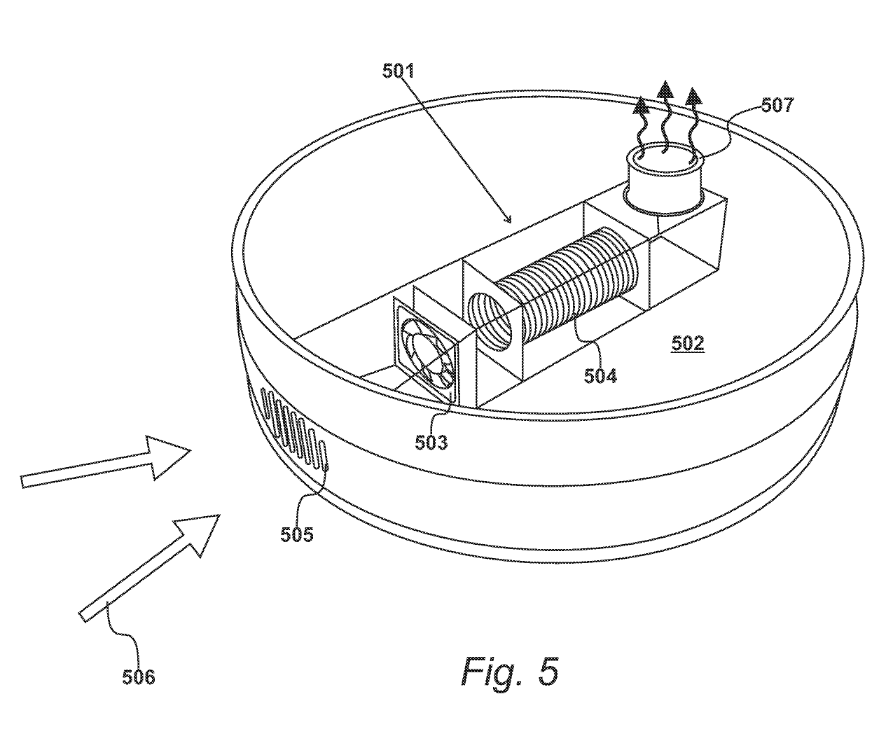

Heating mechanism 202 is configured to apply heat to internal cavity 105 to maintain waste bag 103 in the compacted state. An example heating mechanism will be described with respect to FIG. 5.

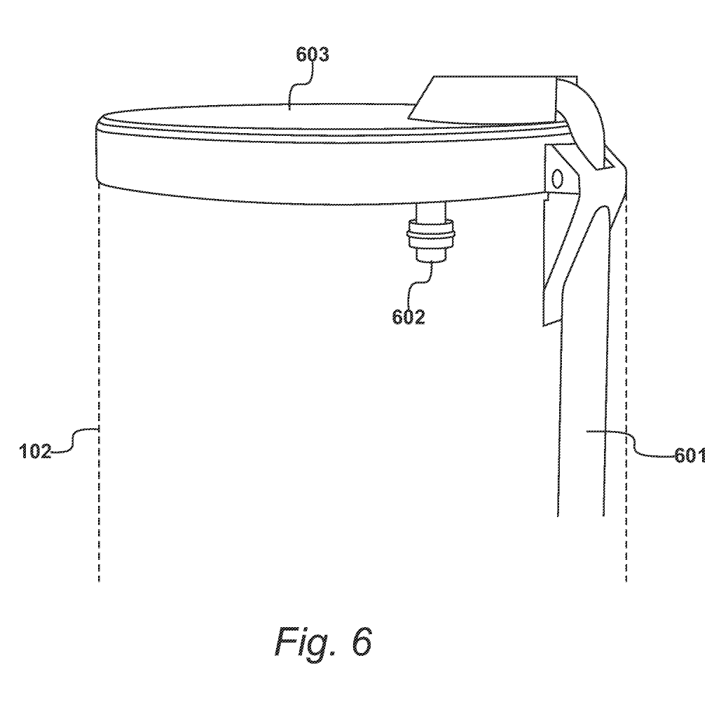

Closure mechanism 203 is configured to secure waste bag 103 in a closed configuration. Example closure mechanisms will be described with respect to FIGS. 6 to 9.

### FIG. 3

An example suction mechanism in accordance with an aspect of the present invention is shown in FIG. 3. Suction mechanism 301 is shown with container 102 not fully shown for viewing purposes. Suction mechanism 301 is configured to extract a fluid, such as air, from an interior of a waste bag so as to compact the waste bag to a compacted state.

In the embodiment, suction mechanism 301 comprises a vacuum turbine. The vacuum turbine is powered by the power source and, in use, rotates to create a vacuum thereby drawing fluid from inside the waste bag via outlet tube 302. Outlet tube 302 is therefore connected to the turbine 303 to enable fluid to be extracted. Extracted fluid can be deposited into the cavity 304 in the bottom of container 102 where it can be released to the atmosphere by via venting holes 106.

For this purpose, a carbon filter can be included in container 102 which is configured to absorb odors which have originated from the waste in the waste bag. In particular, removed air from inside the waste bag is likely to be contaminated with odors from the waste, and by passing the removed air through the carbon filter, any such odors are not released into the surrounding area.

### FIG. 4

An alternative suction mechanism in accordance with the present invention is shown in FIG. 4. Suction mechanism 401 is shown with container 102 not fully shown for viewing purposes. As with the embodiment of FIG. 3, suction mechanism 401 is configured to extract a fluid, such as air, from an interior of a waste bag so as to compact the waste bag to a compacted state.

In the embodiment, suction mechanism 401 comprises a vacuum module 402 which is positioned in the bottom of container 102. Vacuum module 402 may be any suitable vacuuming suction mechanism available which enables air to be drawn towards it. In this embodiment, input device, in the form of pedal 403 is utilized to activate suction mechanism 401 which provides suction via suction tube 404 and extracts air from a waste bag into outlet tube 405. Outlet tube 405 provides extracted air into the bottom part 406 of container 102 which again can then be vented through venting holes 407. Again, venting holes 407 include a carbon filter which is configured to absorb odors originating from the waste in the waste bag.

It is appreciated that, in respect of the examples shown in FIGS. 3 and 4 that the suction mechanism is positioned in the bottom of the container. However, in alternative embodiments, the suction mechanism may be incorporated into another part of the container such as the lid, and in one embodiment, in the lid of the container in combination with the battery for powering it. This would reduce the amount of tubing required for providing a vacuum and extracting the air, however, it is envisaged that the extracted air may still be extracted via an outlet tube which vents via the bottom of the container. Any other suitable variations on this are considered within the scope of the invention, particularly in terms of where the suction mechanism and its components are placed.

### FIG. 5

A heating mechanism 501 in accordance with the present invention is described with respect to FIG. 5. Heating mechanism 501 is configured to apply heat to the internal cavity 105 of container 102. In the embodiment, heating mechanism 501 is again positioned in a lower cavity 502 in container 102, and, while not shown in this Figure, may also include a suction mechanism alongside.

In the embodiment, heating mechanism 501 comprises a fan 503 powered by a motor and a heating element 504. The fan and motor arrangement are provided with power from the aforementioned power supply. In use, upon activation, the power supply powers the motor to enable the fan to rotate, thereby pulling in air from the atmosphere into fan 503 through venting holes 505, as indicated by arrows 506. The intake air then passes through the heating element 504 which comprises a coiled copper element which heats the air as it passes through towards the heating outlet 507. Hot air can therefore be passed from heating outlet 507 into the internal cavity 105 of container 102 which is positioned above the heating mechanism.

As an alternative to the venting holes described, in a further embodiment, the container is mounted onto feet such that there is a gap between the container and a supporting surface. On the bottom of the container surface therefore, a plurality of holes is included so that air can enter the container from underneath rather than from the side. This may present a more aesthetically pleasing option for a user.

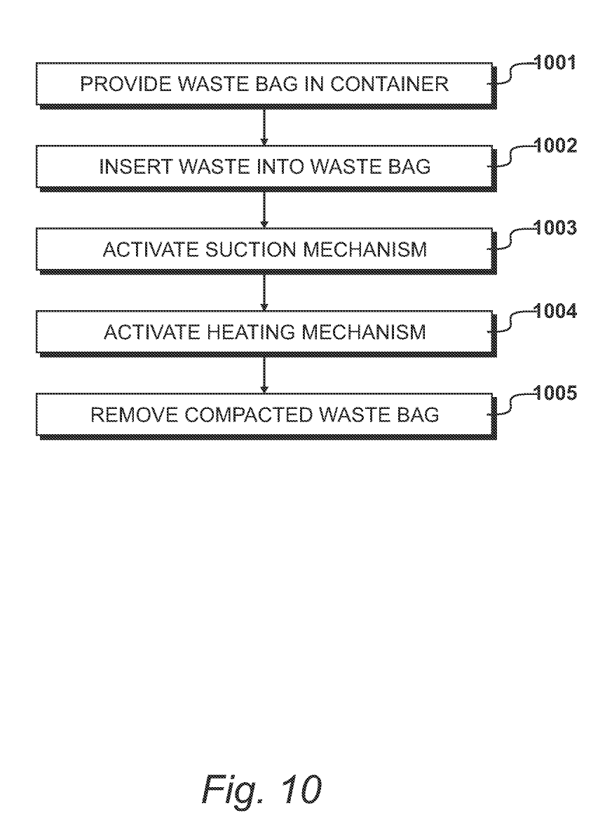

In the embodiment, it is appreciated that the heating mechanism is separated from the internal cavity 105 by means of a plate extending across the cross-sectional diameter of the container. Thus, when a user looks into an empty container, the heating mechanism (and suction mechanism included) is obscured from view in normal use. In an embodiment, the plate includes a plurality of apertures which allows warm air therethrough such that heated air can pass into the internal cavity in the manner described in FIGS. 10 to 12.

In an alternative embodiment, instead of the heating mechanism being positioned at the bottom of the container, it is appreciated that in an alternative embodiment a plurality of nozzles could be incorporated into the sides of the container which are configured to blow hot air into the internal cavity and around the waste bag.

### FIG. 6

Embodiments of closure mechanisms which are configured to secure a waste bag in a closed configuration are shown in respect of FIGS. 6 to 9.

FIG. 6 shows a first closure mechanism which may be utilized with any of the suction and heating mechanisms previously described.

Outlet tube 601 is configured to extract air from a waste bag which, when suction is required, is fitted over a connection port 602 which forms part of a lid 603 of container 102. In this embodiment, when the waste bag is full of waste, a user wraps the opening of the waste bag around the connection port 602 and secures the waste bag in place by means of a gasket or clip. The heating and suction mechanism is then activated and once completed, the bag can be removed and tied by a user.

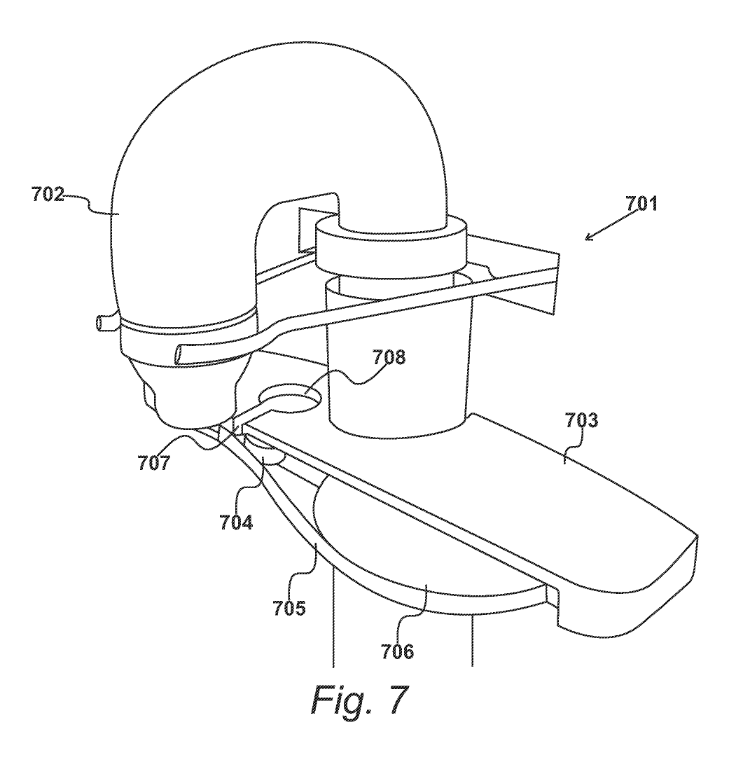

### FIG. 7

A further embodiment illustrating a closure mechanism 701 is shown in FIG. 7. Outlet tube 702 is again connected to an appropriate suction mechanism and extracts air from a waste bag in container 102 thereby compacting the waste bag and waste therein. Following the heating process to maintain the waste bag in the compacted state, the waste bag can be sealed by closure mechanism 701.

Closure mechanism 701 comprises a tape sealer 703 which comprises rollers 704, adhesive tape 705 provided on a roll 706 and a slot 707 configured to receive a waste bag. When securing of the bag in a closed configuration is required, a user pushes the neck of a waste bag through the slot 707 against the force of the rollers 704 and into aperture 708. This leads to tape being wrapped around the neck of the bag, sealing it in place. This closure mechanism operates in a similar way to conventional methods for sealing bread loaves in plastic bags.

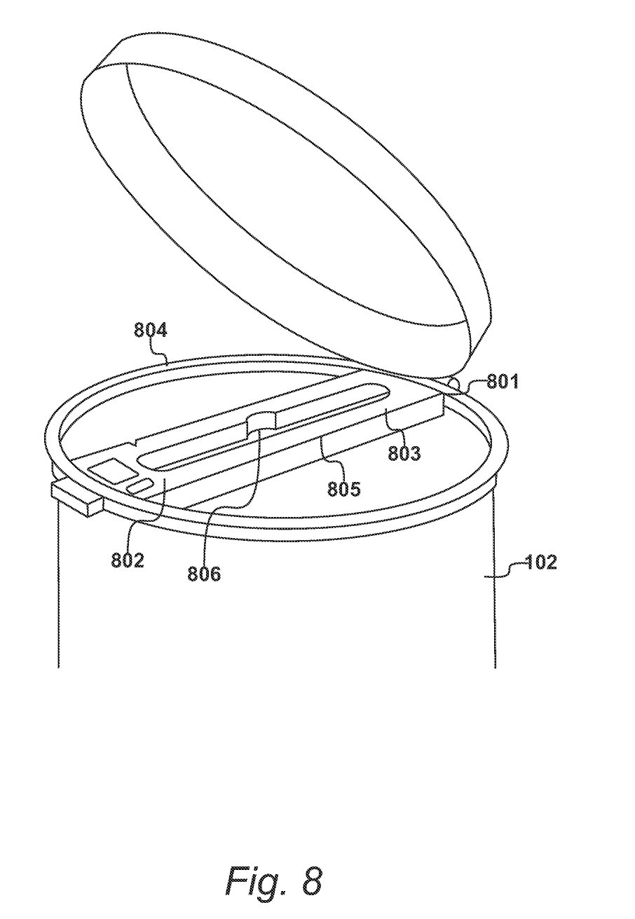

### FIG. 8

An alternative closure mechanism 801 is shown in FIG. 8. Positioned across the cross section of the cylinder of container 102, closure mechanism 801 comprises a heat-sealing device 802 which is configured to apply heat around the neck of a waste bag such that the neck fuses together from the heat. In the embodiment, the heat-sealing device 802 comprises an adjustable clamp 803 which includes a first part 804 and a second part 805. Parts 804 and 805 are configured to mutually co-operate to form a slot 806 which is suitable for receiving a waste bag. Each of the parts 804 and 805 are moveable from a first position (in which they are separated to allow access to the opening of a waste bag so that waste can be received) to a second position (in which they form slot 806 as shown).

In use, the waste bag is positioned over each of the parts 804 and 805 so that waste can be inserted into the waste bag normally. When the waste bag is full, the system is activated so that the suction mechanism and heating mechanism are operated. The closure mechanism is also operated such that part 804 and part 805 are brought together so as to clamp the waste bag. Heat is then applied to neck of the bag by the closure mechanism, utilizing the heating mechanism to provide the heat. It is appreciated that in alternative embodiments, an additional mechanism may be provided to provide the heat-sealing capacity without using the existing heating mechanism.

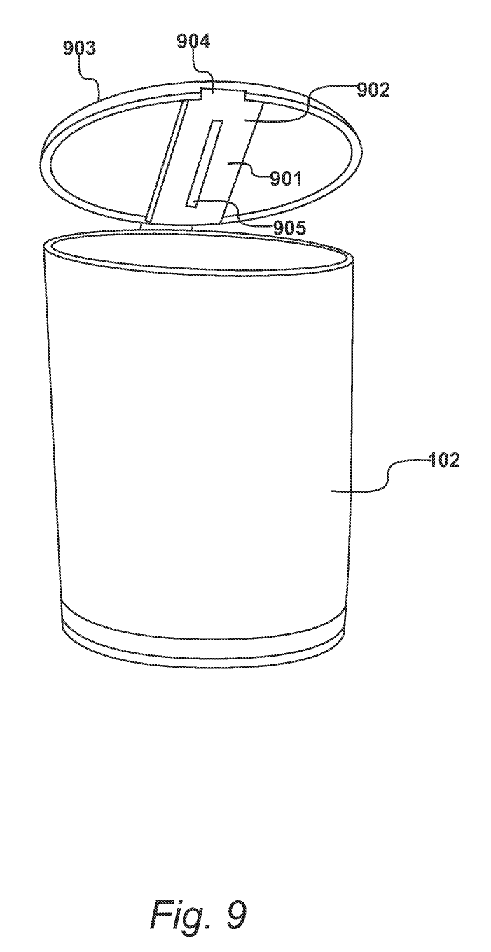

### FIG. 9

In a further embodiment, closure mechanism 901 is similar to closure mechanism 801, however, in this embodiment, clamp 902 is positioned in the lid 903 of container 102. In this illustrated example, clamp 902 is brought into the position of the clamp in FIG. 8 by pulling a tab 904 downwards into container 102 so that slot 905 can receive the neck of a waste bag.

Heat sealing can then be applied in a similar manner to the embodiment of FIG. 8 via heating mechanism or an additional heating mechanism which operates the heat-sealing capacity only.

### FIG. 10

A method of compacting waste is shown in FIG. 10. To initiate the process, a waste receptacle device comprising a container is provided. A waste bag for receiving waste is provided and placed into the container for receipt of waste at step 1001. At step 1002, the waste receptacle device is utilized in a conventional manner, and waste is inserted into the waste bag so that it can be removed for disposal.

The suction mechanism as described herein is activated at step 1003. Activation can be achieved by means of an activation means in the form of an input device, and may include a push button to activate the process.

Activating the suction mechanism applies suction to the interior of the waste bag to compact the waste bag into a compacted state.

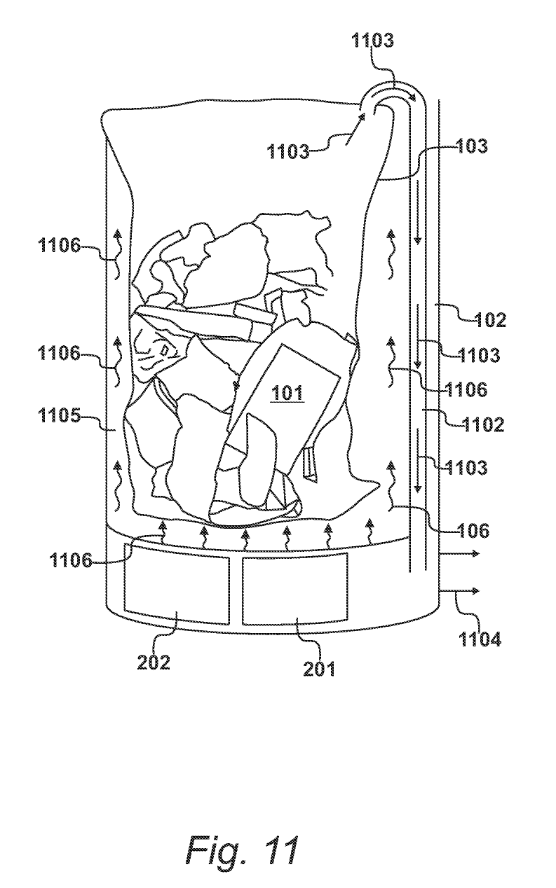

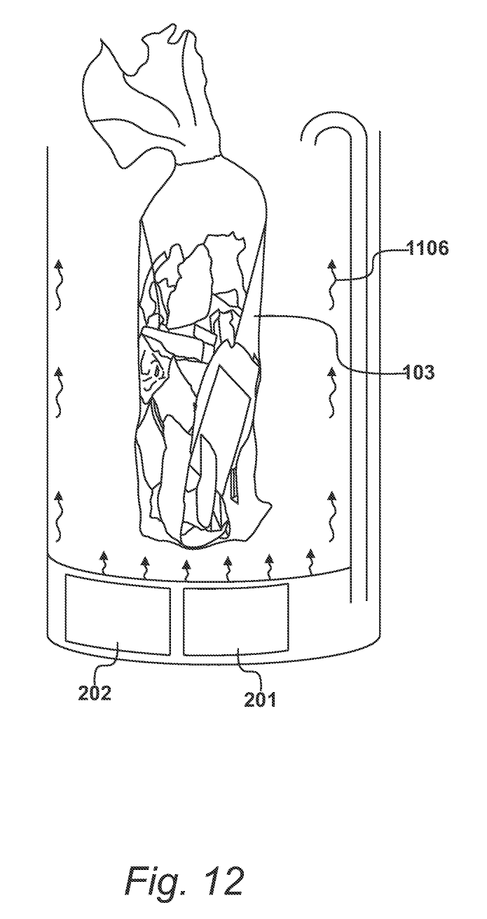

At step 1004, the activation means activates the heating mechanism which provides heat to the internal cavity of the container thereby maintaining the waste back in the compacted state. This is achieved by the activation of the heating mechanism circulating heat around the waste bag by means of its fan, as will be described further in FIGS. 11 and 12.

In an embodiment, the activation means activates the suction mechanism and the heating mechanism by means of an input device in the form of a push button. The input device is pressed which activates the suction mechanism for a predetermined period, before the heating mechanism is activated automatically once the suction mechanism has been active for the predetermined period. This process may incorporate a timer configured to activate each mechanism at required intervals.

For example, in an embodiment, the suction mechanism runs for between fifteen to twenty seconds before the heating mechanism is activated for a further fifteen to twenty seconds. The automatic closure mechanism described in FIG. 8 may then be activated following this to ensure the waste bag is secured in the closed configuration. A specific embodiment requires a single one-button press of the input device to minimize the effort of a user. In this embodiment, the entire process can be completed in the region of thirty-five seconds.

On completion of the previous steps, at step 1005 the compacted waste bag can be removed for disposal.

### FIG. 11

FIGS. 11 and 12 further illustrate the process of compacting waste in accordance with the present invention. In FIG. 11, container 102 has been provided with waste bag 103. Waste bag 103 includes waste 1101 which is ready for compaction. In use, following activation from the activation means, suction mechanism 201, which can be any variation of the suction mechanisms described herein, extracts air via outlet tube 1102, indicated by arrows 1103. This extracted air can then be vented through appropriate venting holes as indicated by arrows 1104.

Following the suctioning step of extracting air, heating mechanism 202 is activated to release heated air into internal cavity 1105 which circulates around waste bag 103 in the manner indicated by arrows 1106.

### FIG. 12

On application of heated air by means of the heating mechanism 202, waste bag 103 shrinks due to the heated air 1106 and is maintained in the compacted state shown in FIG. 12 due to the heat applied.

In the embodiment, waste bag 103 comprises a material which hardens in response to an application of heat such as a shrink-wrapping material. In a specific embodiment, waste bag 103 comprises polyolefin which is a suitable material for this purpose due to its ability to retain its shrunken state once heat has been applied due to it hardening in response to heat. It is appreciated that other suitable materials which provide this capacity may also be used, such as other thin polymers.

The waste receptacle device as described herein has been described as utilized in a substantially domestic environment, however, it is appreciated that, in alternative embodiments, the principles and features described herein are suitable for application into other environments, such as in industrial capacity waste receptacles or commercial enterprises such as office blocks and/or restaurants.

The invention claimed is:

1. A waste receptacle device for compacting waste, comprising:
a container including a waste bag comprising a material which hardens in response to an application of heat;
a suction mechanism configured to extract a fluid such as air from an interior of said waste bag so as to compact the waste bag to a compacted state;
a heating mechanism configured to apply heat to an internal cavity of said container following activation of said suction mechanism to maintain said waste bag in said compacted state; and
a closure mechanism configured to secure said waste bag in a closed configuration; wherein
said closure mechanism comprises a heat-sealing device configured to apply heat around the neck of said waste bag.

2. A waste receptacle device according to claim 1, wherein said suction mechanism comprises an outlet tube and a turbine, said turbine being configured to extract the fluid through said outlet tube.

3. A waste receptacle device according to claim 1, further comprising a power source configured to power said suction mechanism and said heating mechanism.

4. A waste receptacle device according to claim 3, wherein said power source is a rechargeable battery.

5. A waste receptacle device according to claim 4, wherein said container comprises a lid and said rechargeable battery is integrated into said lid.

6. A waste receptacle according to claim 1, wherein said closure mechanism comprises an adjustable clamp comprising a slot.

7. A waste receptacle device according to claim 1, further comprising a plurality of venting holes.

8. A waste receptacle device according to claim 1, wherein said heating mechanism comprises a fan and a heating element.

9. A waste receptacle device according to claim 1, further comprising an activation means for activating said suction mechanism and said heating mechanism.

10. A waste receptacle device according to claim 9, wherein said activation means comprises an input device.

11. A waste receptacle device according to claim 1, wherein said container comprises a carbon filter configured to absorb odors from waste in said container.

12. A waste receptacle device according to claim 1, wherein said material of said waste bag comprises polyolefin.

13. A method of compacting waste, comprising the steps of:
providing a waste bag in a container for receiving waste, said waste bag comprising a material which hardens in response to an application of heat;
applying suction by means of a suction mechanism to the interior of said waste bag to compact said waste bag to a compacted state;
providing heat to an internal cavity of said container by means of a heating mechanism to maintain said waste bag in said compacted state; and
securing said waste bag in a closed configuration by activating a closure mechanism comprising a heat-sealing device which applies heat around the neck of said waste bag.

14. A method according to claim 13, wherein said heating mechanism comprises a fan and said method further comprises the step of:
circulating heat around said waste bag by means of said fan.

15. A method according to claim 13, further comprising the step of:
activating said suction mechanism by an activation means; and
activating said heating mechanism by said activation means.

16. A method according to claim 15, wherein said activation means comprises an input device, and said step of activating said suction mechanism comprises the step of:
pressing said input device to activate said suction mechanism for a predetermined period; wherein
said step of activating said heating mechanism is activated once said suction mechanism has been activated for said predetermined period.
